(19) United States
(12) Patent Application Publication
(10) Pub. No.: US 2003/0190930 A1
(43) Pub. Date: Oct. 9, 2003

(54) Method in a third generation or higher telecommunications network of updating other radio network controllers controlling neighbour cells with information on a change or changes relating to a first cell, and corresponding apparatus

(76) Inventors: Seau Sian Lim, Swindon (GB); George Ray Ritchie, Chippenham (GB)

Correspondence Address: Docket Administrator (Room. 3J-219), Lucent Technologies Inc., 101 Crawfords Corner Road, Holmdel, NJ, 07733-3030, US

(21) Appl. No.: 10/405,532

(22) Filed: Apr. 2, 2003

(30) Foreign Application Priority Data
Apr. 3, 2002 (GB) 0207725.3

(51) Int. Cl. H04M 1/00

(52) U.S. Cl. 455/560; 455/561

(57) ABSTRACT

A method is provided in a third generation or higher telecommunications network of updating other radio network controllers controlling neighbour cells referred to in a list of neighbour cells recorded at a first radio network controller RNC controlling a first cell. The updating is with information on a change or changes relating to said first cell by transmitting the information direct to each of the radio network controllers RNCs to be updated.

### CROSS REFERENCE TO RELATED APPLICATION

This application claims priority of European Application No. 0207725.3 filed on Apr. 3, 2002.

### TECHNICAL FIELD

The present invention relates to a method in a third generation or higher telecommunications network of updating other radio network controllers controlling neighbour cells referred to in a list of neighbour cells recorded at a first radio network controller RNC controlling a first cell, the updating being with information on a change or changes relating to said first cell. The present invention also relates to a third generation or higher telecommunications network. The present invention also relates to a third generation or higher telecommunications radio network controller RNC. The present invention also relates to a third generation or higher telecommunications operations and management centre OMC-U.

### BACKGROUND OF THE INVENTION

A Universal Mobile Telecommunications System UMTS telecommunications network is a so-called third generation telecommunications network. A UMTS terrestrial radio access network UTRAN is a public land mobile network PLMN controlled by a network management centre NMC which provides a package of end-user functions and is responsible for the management of the whole public land mobile network PLMN. Under the control of the network management centre NMC is at least one UTRAN Operation and Maintenance Centre (OMC-U), each of which contains a set of so-called element managers. Each element manager manages an interface to a network element such as a radio network controller RNC or base station (NodeB, in UMTS terminology).

Each base station has (e.g. three) directional antennas each transmitting in a corresponding (e.g. 120 degree) sector. Each base station has several cells in the sense of permitted combinations of sector and carrier frequency pair (one carrier uplink, one carrier downlink).

The current procedures for exchanging cell status and cell related information are shown in FIGS. 1 to 3. FIG. 1 illustrates the exchange of cell status and cell related information between two RNCs under the control of the same OMC-U. FIG. 2 illustrates how information is transferred from one RNC to another. FIG. 3 illustrates the exchange of cell status and cell related information between two RNCs under the control of different OMC-Us. A lot of manual and tedious tasks by the operator of each OMC_U at the network management centre NMC are undertaken to update at each RNC the information on neighbouring cells, as well as storing information on cells temporarily unavailable for use until back to normal (i.e. having an administration state of “unlock” and an operational state of “enabled”). As shown in FIG. 2, the exchange of information on neighbouring cells goes beyond the boundary of control of one OMC-U to other OMC-Us. As the operator would have to update the data server within each of the RNCs affected by a change in the cell status information on one cell controlled by a RNC, and this is a manual and tedious task, normally the information is not updated.

If the information is not updated, significant performance degradation results. In particular, IuR bandwidth is wasted due to radio link setup/addition failures. There is unnecessary wastage of mobile power due to measuring e.g. signal to noise ratios, for handover and cell reselection attempts, on cells which are in. fact unavailable as e.g. disabled. Radio bandwidth is wasted in sending radio resource control RRC messages to that must eventually fail as the cell is unavailable.

### SUMMARY OF THE INVENTION

The present invention provides a method in a third generation or higher telecommunications network of updating all other radio network controllers controlling neighbour cells referred to in a list of neighbour cells recorded at a first radio network controller (RNC) controlling a first cell with information on a change or changes relating to said first cell, by the first radio network controller (RNC) being instructed to notify changes relating to said first cell to all said other radio network controllers, and transmitting the information direct from the first radio network controller (RNC) to each of the radio network controllers (RNCs) to be updated.

In preferred embodiments an improved mechanism is provided for transmission of information about neighbouring cells under the control of other RNCs and possibly other OMC-Us by informing the peer RNC of the cell status of a neighbouring cell. This avoids the requirement of known UMTS networks that exchange of neighbour cell relations and information between RNCs controlled by an OMC-U are performed via the OMC-U.

The advantages of preferred embodiments are numerous, and include simplifying operator workload i.e. fewer manual and tedious tasks for the human operators, and reduced wastage of luR bandwidth due to radio link setup/addition failures. Other advantages include reduced mobile power consumption due to measuring e.g signal to noise ratio for handover and cell reselection attempts on cells which are in fact unavailable as e.g. disabled, and less wastage of radio bandwidth in particular in sending radio resource control RRC messages to cells that must eventually fail as the cell is unavailable.

Preferably the transmission is direct in being via a respective IuR interface between the first RNC and each of the other RNCs.

Preferably one change is a change in operational state. Preferably the new operational state is Enabled or Disabled.

Preferably one change is in administration state. Preferably the new administration state is Lock, Unlock or Shutting down.

Preferably one change is a change in one of maximum transmission power, primary scrambling code, transmit diversity status, or carrier frequency.

Preferably one change is whether the first cell should be included in a list of neighbour cells of a cell which is one of the neighbour cells to the first cell, that list being recorded at one of said other RNCs.

Preferably the other RNCs are under the control of the same OMC-U as the first RNC.

Alternatively preferably at least one of the other RNCs is under the control of a different OMC-U to the first RNC.

Preferably the third generation or higher telecommunications network is a UMTS telecommunications network.

The present invention also provides a third generation or higher telecommunications network comprising a first radio network controller RNC operative to control a first cell, and other radio network controllers, the first radio network controller being operative to store a list of neighbour cells and, being instructed to notify changes relating to said first cell to all said other radio network controllers, to update all the other radio network controllers controlling the neighbour cells referred to in the list, the updating being with information on a change or changes relating to said first cell by transmitting the information direct to each of the other radio network controllers.

Preferably the transmission is direct in being via a respective IuR interface between the first RNC and each of the other RNCs.

The network is preferably a UMTS telecommunications network.

The present invention also provides a third generation or higher telecommunications radio network controller (RNC) operative to control a first cell and to store a list of neighbour cells and, being instructed to notify changes relating to said first cell to all said other radio network controllers, to update all other radio network controllers controlling the neighbour cells referred to in the list, the updating being with information on a change or changes relating to said first cell by transmitting the information direct to each of the other radio network controllers.

Preferably the transmission is direct in being via a respective IuR interface.

Preferably the radio network is a UMTS radio network controller.

The present invention also provides a third generation or higher telecommunications operations and management centre OMC-U operative to control a first radio network controller (RNC) to (a) control a first cell, to (b) store a list of neighbour cells and to (c) update all other radio network controllers controlling the neighbour cells referred to in the list with information on a change or changes relating to said first cell, by transmitting the information direct to each of the other radio network controllers, the OMC-U instructing the first radio network controller (RNC) to notify changes relating to said first cell to all said other radio network controllers.

Preferably the operations and management is a UMTS OMC-U.

### BRIEF DESCRIPTION OF THE DRAWINGS

A preferred embodiment of the present invention will now be described by way of example and with reference to the drawings, in which:

FIG. 1 is a diagram illustrating known exchange of cell status information and related information between two RNCs under the control of one OMC-U (prior art),

FIG. 2 is a diagram illustrating a known time sequence diagram of the transfer of the information from one of the RNCs to the other as shown in FIG. 1 (prior art),

FIG. 3 is a diagram illustrating known exchange of cell status information and related information between two RNCs on different OMC-Us (prior art),

FIG. 4 is a diagram illustrating a preferred UMTS radio access network UTRAN,

FIG. 5 is a diagram illustrating interfaces between network elements

FIG. 6 is a diagram illustrating exchange of cell status information and related information between two RNCs within an OMC-U,

FIG. 7 is a diagram illustrating a time sequence diagram of passage of cell status from one of the RNCs to the other as shown in FIG. 6,

FIG. 8 is a diagram illustrating exchange of cell status between two RNCs on different OMC-Us.

### DETAILED DESCRIPTION

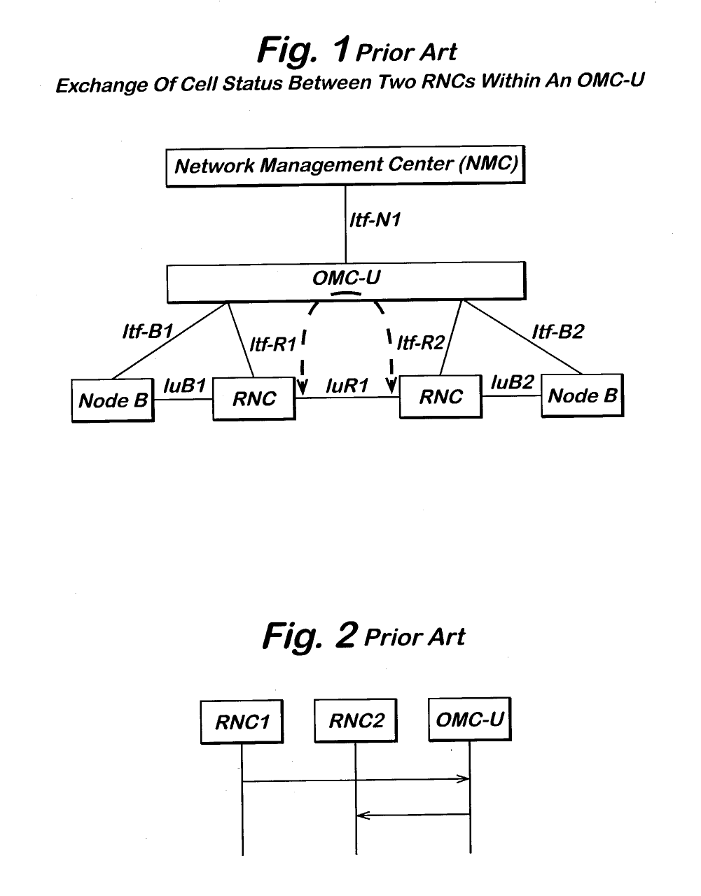

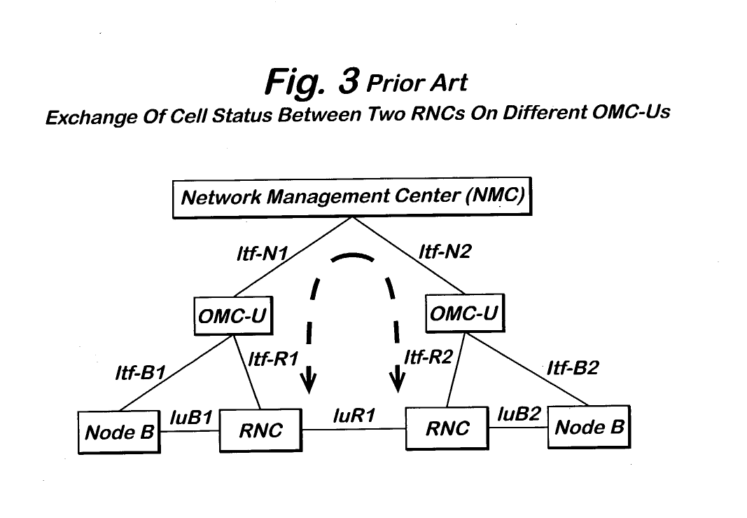

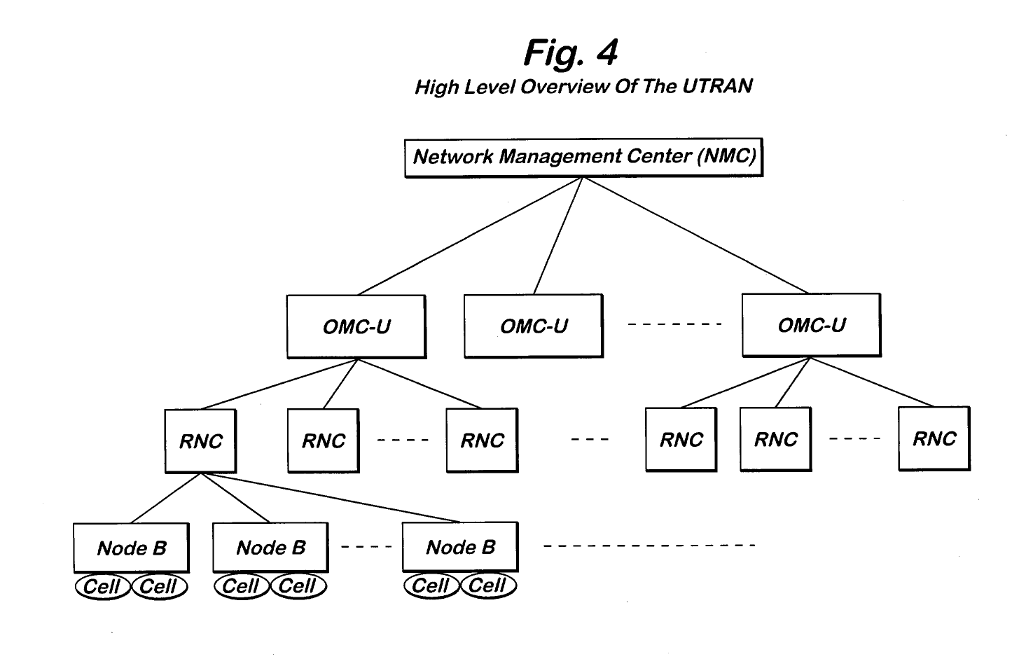

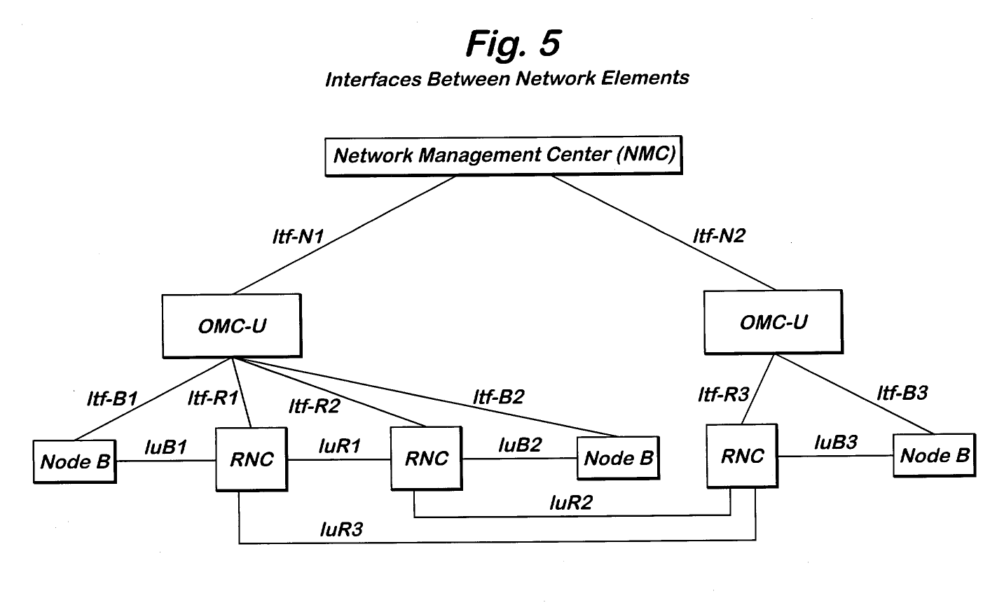

The high level overview of a preferred Universal Mobile Telecommunications System UMTS terrestrial radio access network UTRAN is shown in FIG. 1. A UTRAN is a public land mobile network PLMN controlled by a Network Management Centre NMC which provides a package of end-user functions and is responsible for the management of the whole public land mobile network PLMN. Under the general control of the Network Management Centre NMC is one or more UTRAN Operation and Maintenance Centres (OMC-U) which each have a human operator (not shown) and contains a set of so-called element managers (not shown), each of which manages an interface to a network element such as a radio network controller RNC or base station (NodeB, in UMTS termnology). Radio network controllers each generally control several base stations.

Some of the interfaces present in the preferred network are shown in FIG. 2. It will be seen that each RNC is linked to each other RNC both via an IuR interface and indirectly via an OMC-U, or two OMC-Us and the NMC.

A mechanism of exchanging cell status and other cell-related information between the RNCs and between the OMC-Us is provided. Cell status refers to the administration state and operational state of a cell. The administration state is e.g. locked/unlocked/shutting down. The operational state is e.g. enabled/disabled. Cell related information refers to cell capabilities e.g. maximum transmission power, primary scrambling code, transmit diversity status, e.g. on which of multiple antennas to transmit so as to ameliorate problems due to mutipath scattering), the carrier frequencies selected, etc.

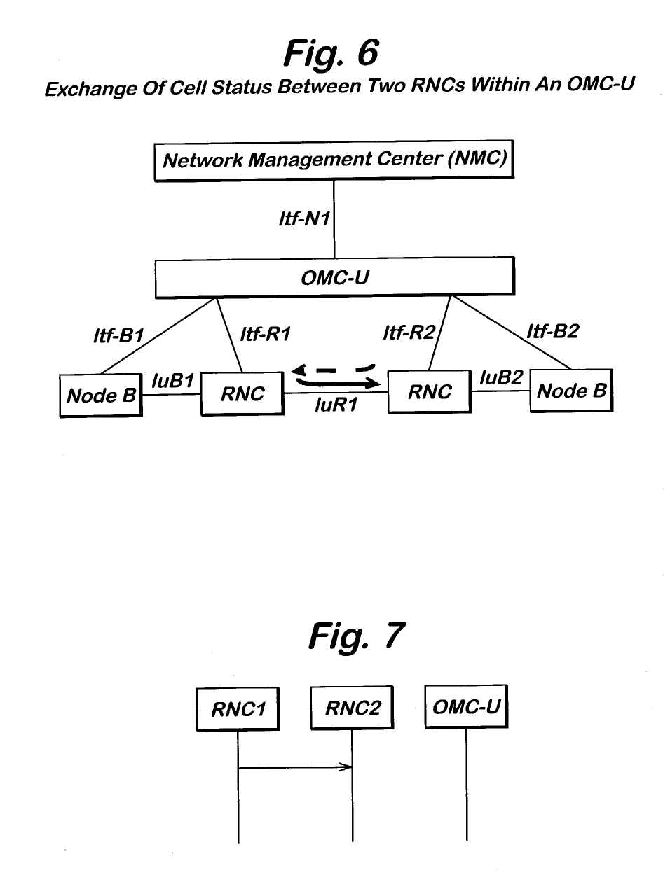

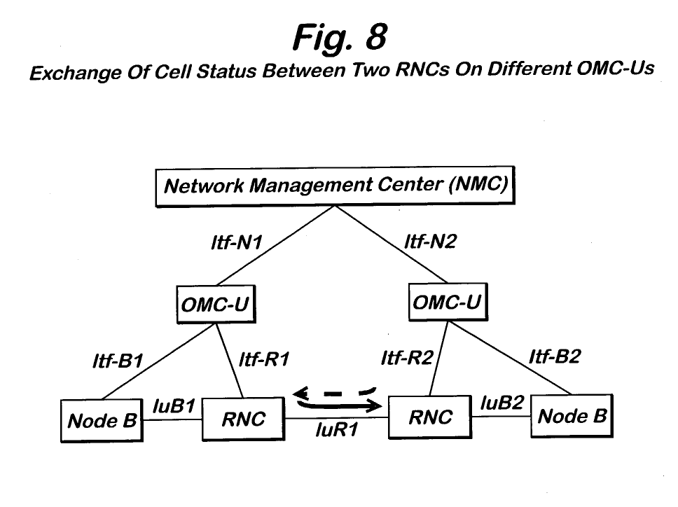

Information of any status changes or related changes to neighbouring cells and any other neighbouring cell information is sent via the IuR, which is the interface between two RNCs. The two RNCs can be under the control of the same OMC-U as shown in FIG. 6, or under the control of different OMC-Us as shown in FIG. 8. Each RNC keeps, for each cell under that RNCs control, a list of neighbour cells. Each RNC is instructed to notify changes to a cell to all RNCs which control its neighbour cells. Hence any change in terms of the administration state or operational state or other information on a neighbouring cell to a cell controlled by one RNC is notified directly over an IuR interface to another RNC having a neighbour cell relationship with that cell. This direct transfer of information from one RNC to another is shown in FIG. 7.

FIGS. 6 and 8 show that any cell status information can be sent via the appropriate IuR interface regardless of whether the RNCs affected are under the control of the same or different OMC-U.

Preferred embodiments provide a means of updating the neighbouring cell relations based on the Admin State and Operational State of each cell in the list of neighbour cells to the cells under its control across an RNC or OMC-U boundary of control. Any other relative static information on neighbouring cells, in particular that may impact the performance of the system if not updated, can be transferred or exchanged.

1. A method in a telecommunications network of updating all other radio network controllers controlling neighbour cells referred to in a list of neighbour cells recorded at a first radio network controller (RNC) controlling a first cell with information on a change or changes relating to said first cell, by the first radio network controller (RNC) being instructed to notify changes relating to said first cell to all said other radio network controllers, and transmitting the information direct from the first radio network controller (RNC) to each of the radio network controllers (RNCs) to be updated.

2. A method according to claim 1 in which the transmission is direct in being via a respective IuR interface between the first RNC and each of the other RNCs.

3. A method according to claim 1, in which one change is a change in operational state.

4. A method according to claim 3, in which the new operational state is Enabled or Disabled.

5. A method according to claim 1, in which one change is in administration state.

6. A method according to claim 5, in which the new administration state is Lock, Unlock or Shutting down.

7. A method according to claim 1, in which one change is a change in one of maximum transmission power, primary scrambling code, transmit diversity status, or carrier frequency.

8. A method according to claim 1, in which one change is whether the first cell should be included in a list of neighbour cells of a cell which is one of the neighbour cells to the first cell, that list being recorded at one of said other RNCs.

9. A method according to claim 1 in which the other RNCs are under the control of a same OMC-U as the first RNC.

10. A method according to claim 1 in which at least one of the other RNCs is under the control of a different OMC-U to the first RNC.

11. A method according to claim 1, in which the telecommunications network is a UMTS telecommunications network.

12. A telecommunications network comprising a first radio network controller RNC operative to control a first cell, and other radio network controllers, the first radio network controller being operative to store a list of neighbour cells and, being instructed to notify changes relating to said first cell to all said other radio network controllers, to update all the other radio network controllers controlling the neighbour cells referred to in the list, the updating being with information on a change or changes relating to said first cell by transmitting the information direct to each of the other radio network controllers.

13. A network according to claim 12 in which the transmission is direct in being via a respective IuR interface between the first RNC and each of the other RNCs.

14. A network according to claim 12, which is a UMTS telecommunications network.

15. A telecommunications radio network controller (RNC) operative to control a first cell and to store a list of neighbour cells and, being instructed to notify changes relating to said first cell to all said other radio network controllers, to update all other radio network controllers controlling the neighbour cells referred to in the list, the updating being with information on a change or changes relating to said first cell by transmitting the information direct to each of the other radio network controllers.

16. A radio network controller according to claim 15 in which the transmission is direct in being via a respective IuR interface.

17. A radio network controller according to claim 15, which is a UMTS radio network controller.

18. A telecommunications operations and management centre OMC-U operative to control a first radio network controller (RNC) to (a) control a first cell, to (b) store a list of neighbour cells and to (c) update all other radio network controllers controlling the neighbour cells referred to in the list with information on a change or changes relating to said first cell, by transmitting the information direct to each of the other radio network controllers, the OMC-U instructing the first radio network controller (RNC) to notify changes relating to said first cell to all said other radio network controllers.

19. An operations and management centre according to claim 18, which is a UMTS OMC-U.
